(19) United States
(12) Patent Application Publication
(10) Pub. No.: US 2012/0304875 A1
(43) Pub. Date: Dec. 6, 2012

(54) Embossing wheel and Anvil for Braille Printer

(75) Inventors: David Pillischer, Riverdvale, NJ (US); Jeffrey C. Robertson, Rochester, NY (US); Lowell Onderdonk, Canandaguia, NY (US)

(73) Assignee: ELECTRONIC BRAILLER, INC., Baltimore, MD (US)

(21) Appl. No.: 13/312,728

(22) Filed: Dec. 6, 2011

Related U.S. Application Data
(63) Continuation-in-part of application No. 11/940,323, filed on Nov. 15, 2007, now abandoned.
Application No. 11/940,323 is a continuation-in-part of application No. 12/271,933, filed on Nov. 17, 2008, now abandoned.

(51) Int. Cl. B41F 19/02

(52) U.S. Cl. 101/24

(57) ABSTRACT

A device for embossing Braille characters on an embossable substrate includes a embossing wheel and an anvil. The head containing a series of locations. The locations contain a combination of pins or divots and are configured to print one or more columns of a Braille cell. The anvil is configured with a series of grooves for mating with the pins of the embossing wheel. Embossing occurs when the anvil or embossing wheel is moved against the other and the embossable substrate is made to conform to the depressions in the locations where a pin on the embossing wheel is positioned. An embossed Braille cell can be unembossed by aligning the divots in the Braille embossing wheel with ridges formed between the grooves of the anvil.

### BACKGROUND OF THE INVENTION

1. Field of the Invention

The invention relates to a embossing wheel having an embossing wheel with a combination of pins for a Braille printing machine. More particularly, the printer head of the present invention is especially useful in a printing machine interfaced with a printer which is provided with the appropriate software for formulating pages of Braille text from an input.

2. Description of the Related Art

Various types of high speed printers have been devised for generating a so-called hard copy or paper output from various data and word processing machines, e.g., high speed digital computers. Among these various types is one class of printing mechanism often referred to as a dot matrix printer. Typically, in these devices, a embossing wheel carrying a plurality of impact pins is traversed across the paper and the pins are actuated in an organized sequence to create recognizable print characters. This has been useful for ink printing where the impact force required to transfer the ink from the ribbon to the paper is relatively low. However, in other types of printing, particularly embossing or raised letter printing the impact force is many times greater. One such type of raised letter printing is Braille.

The Braille system, devised in 1821 by Frenchman Louis Braille, is a method that is widely used by blind people to read and write. Each Braille character or cell is made up of six dot positions, arranged in a rectangle containing two columns of three dots each. A dot may be raised at any of the six positions to form sixty-four (2⁶) combinations, including the combination in which no dots are raised. For reference purposes, a particular combination may be described by naming the positions where dots are raised, the positions being universally numbered 1 to 3, from top to bottom, on the left, and 4 to 6, from top to bottom, on the right. For example, dots 1-3-4 would describe a cell with three dots raised, at the top and bottom in the left column and on top of the right column, i.e., the letter m. see FIG. 1a.

Braille has also been extended to an 8-dot code, see FIG. 1b, particularly for use with Braille embossers and refreshable Braille displays. In 8-dot Braille the additional dots are added at the bottom of the cell, giving a matrix 4 dots high by 2 dots wide. The additional dots are given the numbers 7 (for the lower-left dot) and 8 (for the lower-right dot). 8-dot Braille has the advantages that the case of an individual letter is directly coded in the cell containing the letter and that all the printable ASCII characters can be represented in a single cell. All 256 (2⁸) possible combinations of 8 dots are encoded by the Unicode standard.

In Braille, pages are separated by a line so that you can feel going across the page. Braille characters are much larger than their printed equivalents, and the standard 11″ by 11.5″ (28 cm×30 cm) page has room for only 25 lines of 43 characters. To reduce space and increase reading speed, virtually all Braille books are transcribed in what is known as Grade 2 Braille, which uses a system of contractions to reduce space and speed the process of reading. As with most human linguistic activities, Grade 2 Braille embodies a complex system of customs, styles, and practices.

Dot height is approximately 0.02 inches (0.5 mm); the horizontal and vertical spacing between dot centers within a Braille cell is approximately 0.1 inches (2.5 mm); the blank space between dots on adjacent cells is approximately 0.15 inches (3.75 mm) horizontally and 0.2 inches (5.0 mm) vertically. A standard Braille page is 11 inches by 11.5 inches and typically has a maximum of 40 to 43 Braille cells per line and 25 lines.

Braille may be printed using a zinc printing plate in which character dot impressions are produced. A typesetting machine is then used to produce a printing plate from the zinc printing plate. The printing plate is then pressed onto the surface of the recording medium, e.g., paper, to produce the printed Braille material. This is useful where multiple copies of a particular work are desired. However, it is impractical for single copies of written material, such as personal letters. More recently, special Braille writers have been developed such as Braille typewriters and the like to write Braille.

In Braille typewriters, Braille is printed on a recording medium, such as paper, using a hard Braille plate employed as a working die and a printing rod having a pin-shaped projection employed as an embossing die. Other, more conventional, but nonetheless electronic Braille printers are also known. For instance, in U.S. Pat. No. 4,488,828, Ohtsuki utilizes solenoids to print Braille characters one at a time, typewriter-style. This utilizes a single solenoid permitting a simpler design; however, it is very time consuming to print a full line or page of Braille, as a character can contain as many as six raised dots.

It is known, in general, to provide a computer driven Braille printing machine. There are, in fact, several such printers in the market today. For instance, in U.S. Pat. No. 3,380,269 issued Apr. 29, 1975 to Carboneau, a Braille printer is disclosed in which, lines of Braille dots are printed (i.e. embossed for touch reading) simultaneously (three consecutive such lines of dots comprising a line of Braille characters) as paper is drawn lengthwise through a printer (usual typewriter fashion). The dots are printed by a line of Braille printing pins. There is one printing pin for each potential dot across the paper. Each pin travels in a guide path bored in a frame and is actuated by a lever which is powered by a solenoid. Actuation of the solenoid pulls its associated lever downwardly, causing the opposite end of the lever to power the pin upwardly into the substrate paper. Such a printing head essentially divides up a page into as many vertical columns as it has printing pins, and prints a page in a corresponding fraction of the time it would take a machine with a printing head having only one pin. This is certainly a functional arrangement for a printer, but it requires a solenoid-lever-pin combination for each dot in a line of Braille dots. Moreover, this device requires a large rigid frame on which the many solenoid-lever-pin combinations can be mounted.

The trend in high-speed printing has been, as noted above in relation to Carboneau, to abandon the concept of a moving head, in favor of a system providing a single Braille printing pin for each vertical row of Braille dots on a page. However, the large rigid frame and multitude of solenoids is cost prohibitive for individual consumers. Further, each solenoid must be maintained adding further cost.

### SUMMARY OF THE INVENTION

The present invention relates to an embossing print head having a combination of pins for a Braille printing machine. More particularly, the printer head of the present invention is especially useful in a printing machine interfaced with a computer which is provided with the appropriate software for formulating pages of Braille text from an input of sight readable alphanumeric data.

It is an object of the present invention to provide for a novel print head utilizing a novel embossing wheel for use on a Braille embosser or printer which will imprint a Braille character. The printer head contains a generally round head and an anvil. Paper is inserted in to the embossing wheel and travels between the head and the anvil. The head contains various combinations of pins about its circumference. The combinations of pins are aligned in vertical positions of one column of a Braille character. The head is rotated such that a combination of pins is brought in alignment with the anvil. Thus when the head is moved forward toward the anvil, the paper enters recesses in the anvil in the location of the particular raised pins. This causes an embossed dot or dots to be created on a sheet of paper at a predetermined location. By indexing the embossing wheel and the anvil to the next column the Braille, and repeating, a Braille character is completed. The forward movement of the head and pins to the anvil is limited by small grooves running the length of the anvil on the other side of an inserted sheet of paper on which the Braille impressions are to be embossed. The printer head of the present invention can be traversed across the paper to complete a line of Braille text.

It is another object of the present invention to provide for a novel printer for use on a typewriter or printer which will print a Braille character. The printer contains two or more generally round heads and an anvil. Paper is inserted in to the printer and travels between the head and the anvil. The embossing wheels contains various combinations of pins about the circumference. The combinations of pins are aligned in vertical positions of one column of a Braille character. The each head is rotated such that a combination of pins is brought in alignment with the anvil. Thus when either the embossing wheel or the anvil is moved forward toward the other, the paper is pressed into the anvil in the location of the particular raised pins. This causes an embossed dot or dots to be created on a sheet of paper at a predetermined location. The embossing wheel and the anvil is indexed to the next character position, and repeating, another character is completed. The printer head of the present invention can be traversed across the paper to complete a line of Braille text.

### BRIEF DESCRIPTION OF THE SEVERAL VIEWS OF THE DRAWINGS

FIG. 1 is a diagram of a six dot Braille cell indicating the six dot locations;

FIG. 1a is a diagram of the letter “m” in Braille;

FIG. 1b is a diagram of an eight dot Braille cell indicating the locations of dot 7 and 8;

FIG. 2 is a perspective view of the round embossing wheel according to an aspect of the present invention;

FIG. 3 is top view of the round embossing wheel of FIG. 2;

FIG. 4 is an exploded view of the circumference of the round embossing wheel of FIG. 2 showing the pin combinations;

FIG. 5 is a view of one of the pins of the embossing wheel of FIG. 2;

FIG. 6 is a front view of the anvil according to one aspect of the present invention;

FIG. 7 is a cut away view along line A-A of FIG. 6;

FIG. 8 is an exploded view of a embossing wheel with a four pin configuration according to an aspect of the invention;

FIG. 9 is a perspective view of half cell Braille embossing wheel according to an aspect of the present invention;

FIG. 10 is a right side view of the half cell Braille embossing wheel of FIG. 9;

FIG. 11 is a top view of the half cell Braille embossing wheel of FIG. 9;

FIG. 12 is a cut away view A-A of FIG. 11;

FIG. 13 is a bottom view of an anvil of an aspect of the present invention;

FIG. 14 is a cut away view B-B of the anvil of FIG. 13

FIG. 15 is a side view of the anvil of FIG. 13 and side view of the half cell Braille embossing wheel of FIG. 9 where the half cell Braille embossing wheel is moved into position to delete a Braille impression;

FIG. 16 is a perspective cut away view C-C of FIG. 15.

### DETAILED DESCRIPTION OF THE INVENTION

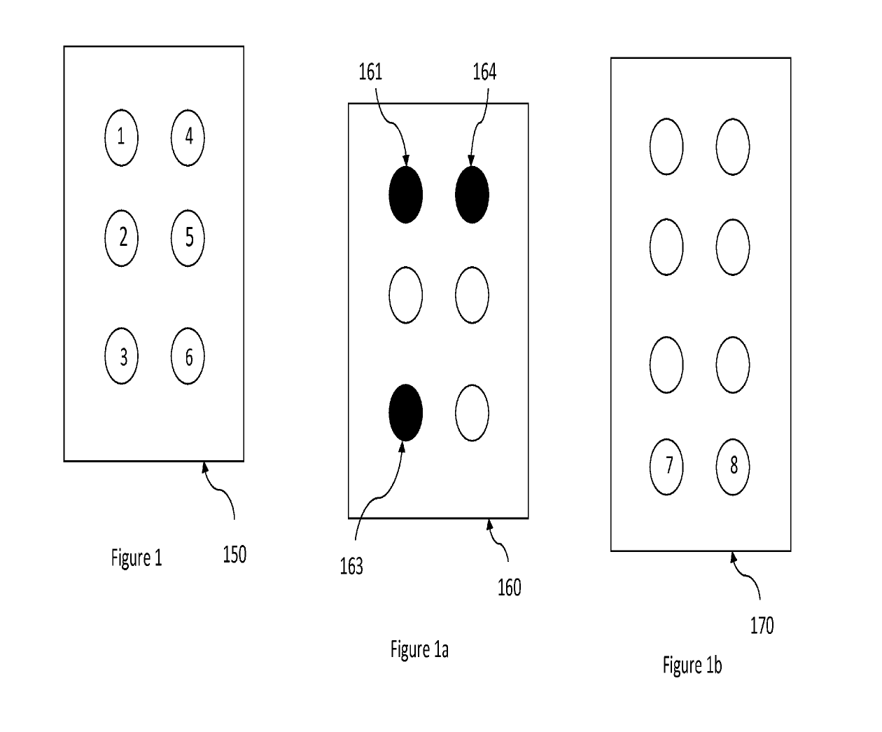

FIG. 1 shows the standard Braille cell 150. Each Braille character or cell 150 is made up of six dot positions, arranged in a rectangle containing two columns of three dots each. A dot may be raised at any of the six positions to form sixty-four (2⁶) combinations, including the combination in which no dots are raised. For reference purposes, a particular combination may be described by naming the positions where dots are raised, the positions being universally numbered 1, 2 and 3, from top to bottom, on the left, and 4, 5 and 6, from top to bottom, on the right. For example, in FIG. 1a the cell 160 has raised dots 161-163-164 and would describe a cell with three dots raised, at the top and bottom in the left column and on top of the right column, i.e., the letter m.

An expanded Braille cell 170 is shown in FIG. 1b. The expanded cell 170 has eight dot locations. The additional locations are added to the bottom of the original two columns and are universally numbered 7 on the bottom left and 8 on the bottom right.

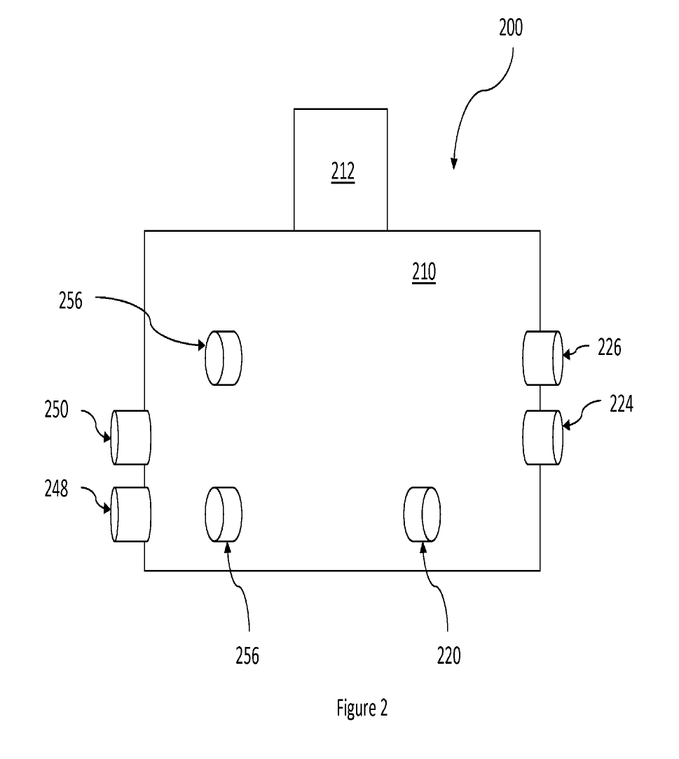

Referring to FIG. 2, the embossing wheel 200 is shown. A shaft 212 permits rotation of the wheel 200 by a motor, not shown. A body 210 is aligned coaxial with shaft 212 and is preferably cylindrical in shape, however, it may be any shape, such as octagonal, that will permit axial orientation of the pins. About the periphery of body 210 are a combination of pins 220, 224, 226, 248, 250, 254 and 256.

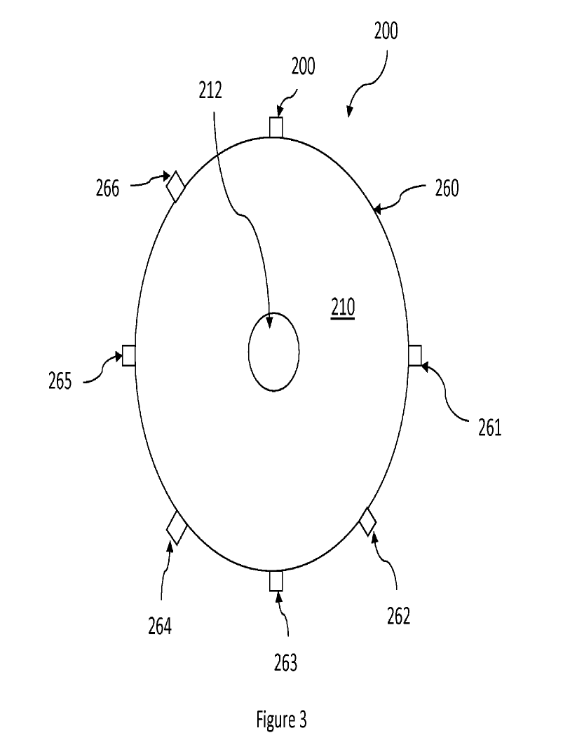

FIG. 3 is a top view of wheel 200. Shaft 212 being smaller then body 210. Body 210 is in axial alignment with shaft 212. The body 210 has a number of pin locations about the periphery equal to 2ⁿ−1 where n equals the number of pins or the number of dots in the Braille cell or a single column of the Braille cell. One of the possible combinations is where no pins are raised thus one location can be subtracted. Thus where a single column of a standard Braille cell is printed, there are 2³−1 or 7 required locations about the periphery each having up to three pins. For an expanded Braille cell the wheel would contain 2⁴−1 or 15 locations about the periphery which may contain up to four pins each. For printing a full Braille cell the print wheel could contain 2⁶−1 equal to 63 or 2⁸−1 equal to 127 locations on the print wheel. An additional location 260 may have no pins to provide for a blank set of dots or a column having no raised dots. Additionally, location 260 may contain a flat raised portion extending from the top to bottom of body 210. This feature can be useful for deleting raised dots by pressing the paper between it and an opposing flat surface on the anvil. The other locations contain at least one pin and represent the reaming potential combinations of the three pin locations. Three locations have a single pin represented by 264 and 265 and 267. Three locations have two pins represented by 262, 263 and 266. One location has three pins represented by 261. The pin for a single column standard Braille cell locations are further shown in FIG. 4.

FIG. 4 shows the periphery of the body 210 as if it were unrolled and laid on a flat surface. Pins 220, 224, 226, 230, 234, 240, 242, 244, 248, 250, 254, 256 represent each of the potential combinations of pins for each of the two columns of a Braille cell. Location 260 represents no raised pins. While, a particular pin or set of pins may be shown in relation to other pin combinations, the pin combinations may be arranged in any manner. Thus, all single pin combinations may be located next to each other as well as all two pin combinations next to each other.

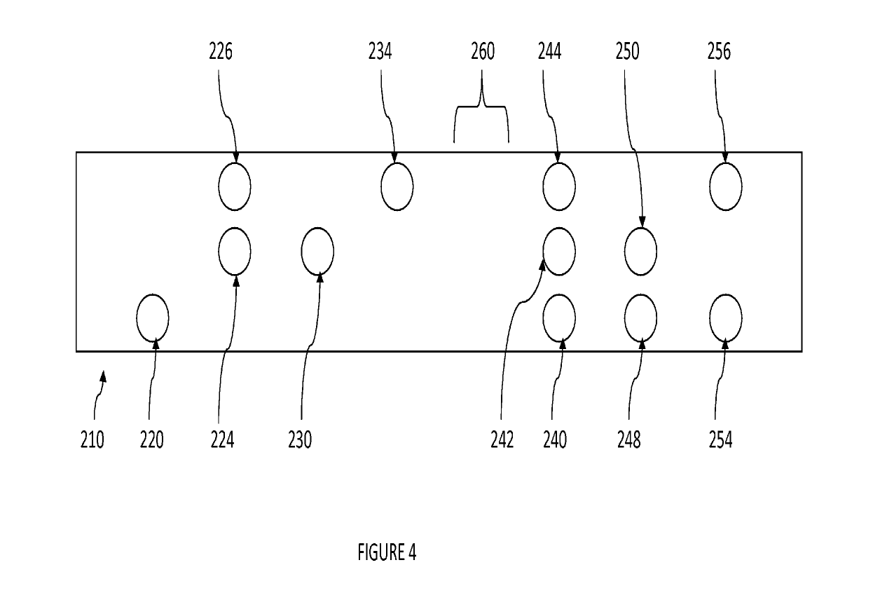

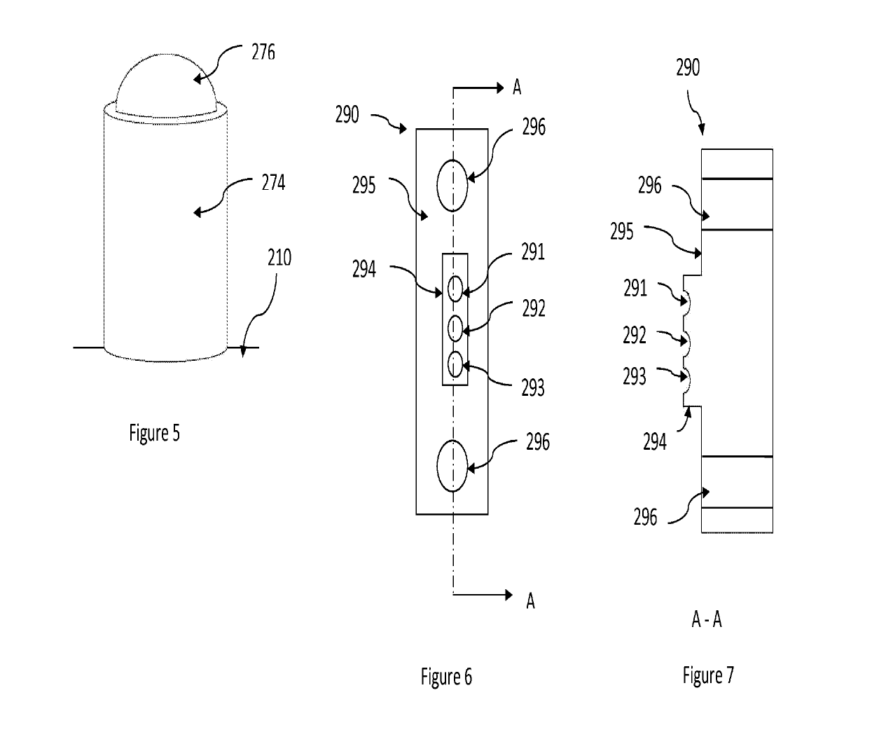

FIG. 5 indicates the shape of a pin. Body 274 may be any height or shape capable of offsetting hammer 276 from the wheel 200. Hammer 276 contacts the paper, forcing the paper to form to the inside of a divot in the anvil, during forming of a raised dot. Hammer 276 is formed slightly smaller than the standard size for a raised Braille dot because the actual raised dot is formed by the inside dimensions of the related divot in the anvil.

The anvil 290 as shown in FIG. 6 has three divots 291, 292, 293 formed in the top of a seat 294. Seat 294 sets the divots above the lower body 295 of the anvil 290. The body 295 may have holes 296 to secure to a cam or solenoid for moving into contact with the paper during embossing of the Braille characters. The divots are aligned with the pins on the body 210 of embossing head 200. The divots 291, 292, 293 form the top of a raised dot. As shown in FIG. 7 divots 291, 292, 293 are semi-circular in depth and are formed only a short distance into the step 294. Divots 291, 292, 293 are defined geometrically by the International Braille Standards which are incorporated by reference.

Where an expanded Braille cell printing mechanism is used the body 210 has 16 locations or sides. A sample of the pin layout is shown in FIG. 8. As the standard pin locations for standard and expanded Braille cells are well known, a sample is not provided, however, based on the forgoing description it is understood how to create a Braille embossing head of the invention with a complete Braille cell set.

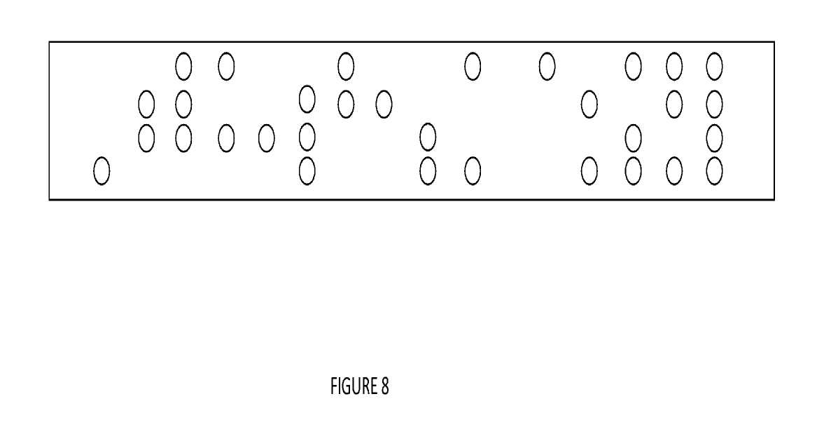

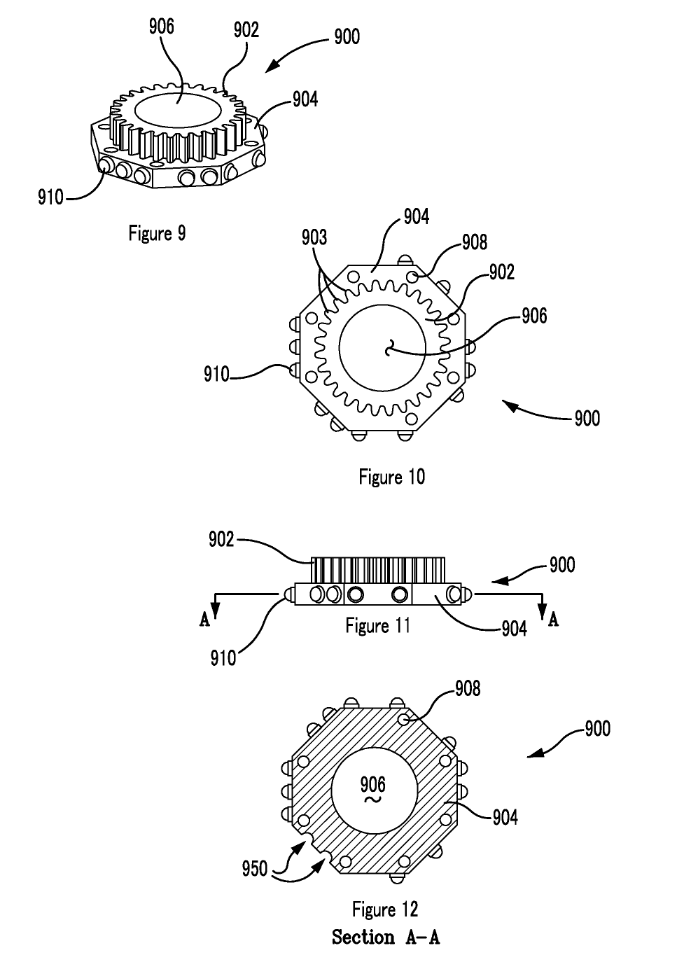

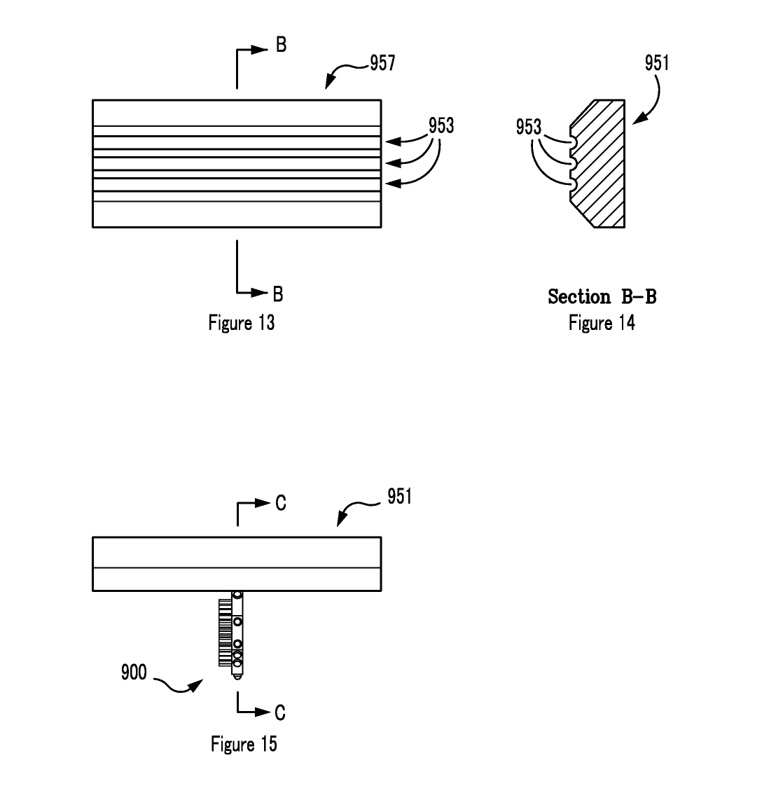

In the alternate embodiment of FIG. 9 a perspective view of half cell Braille embossing wheel 900 is shown. A shaft (not shown) is passed through axial hole 906 to maintain alignment of the half cell Braille embossing wheel 900 during traverse along the width of a page. Gearing or other means 902 is used to index the Braille embossing wheel 900 about its circumference to bring a particular combination of pins 910 in alignment with an anvil 957, such as the anvil 957 of FIG. 13. FIG. 10 is a right side view of the half cell Braille embossing wheel 900 of FIG. 9. FIG. 11 is a top view of the half cell Braille embossing wheel 900 of FIG. 9. Utilizing a pair of Braille embossing wheel 900 permits embossing a full Braille cell. By independently rotating each of the Braille embossing wheels 900 in the pair any combination of pins 910 may be achieved. In a further embodiment two or more pairs of Braille embossing wheel 900 may be used for embossing multiple Braille cells at a time.

In the alternate embodiment of the Braille embossing wheel 900 of FIG. 9, a pair of divots 950 are located on a side of the Braille embossing wheel 900 that has no pins 910 as shown in FIG. 12 which is a cut away view A-A of FIG. 11. The divots 950 are shaped such that a pin 910 could fit within, however it can be slightly larger or smaller then a pin 910 in size. By providing the divots 950 and an anvil 957 of FIG. 13 a user of a Braille embosser with Braille embossing wheel 900 and anvil 957 may perform deletion of embossed Braille impressions. Previously, a user would be required to remove the paper locate the errant Braille impression and rub the impression with a fingernail or other small firm device to flatten out the impression.

FIG. 13 is a bottom view of an anvil 957 of an aspect of the present invention. The anvil 957 has grooves 953 that run the entire length of anvil 957. The grooves are formed to serve two purposes. First during normal operation pins 910 protrude into grooves 957 to produce Braille impressions. Second when a user intends to delete a Braille character, the paper is shifted half a cell up or down to remove the Braille impression.

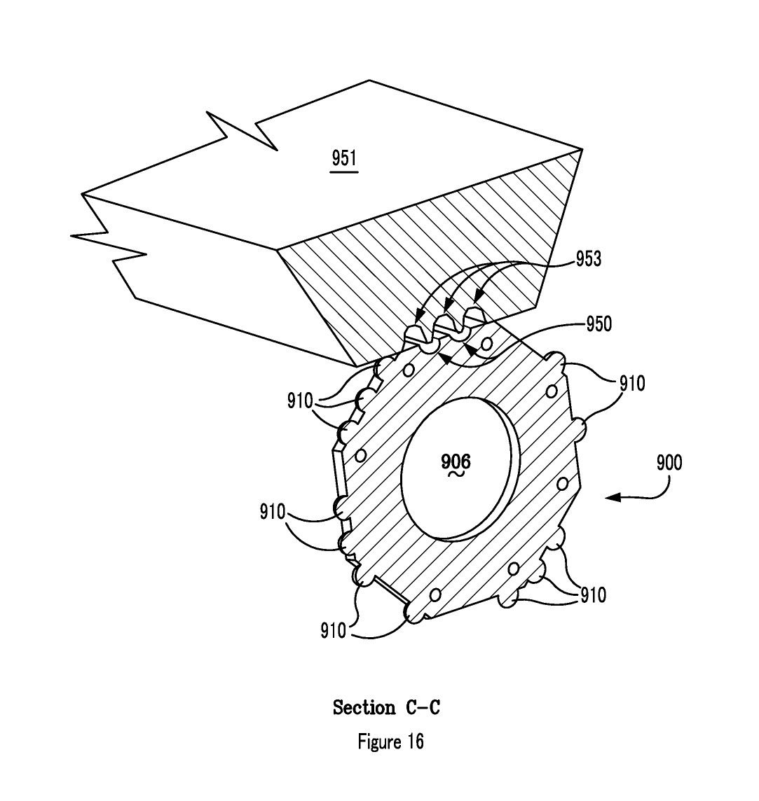

FIG. 14 is a cut away view B-B of the anvil of FIG. 13. FIG. 14 shows the grooves 953 and the resultant ridges between the grooves. FIG. 15 is a side view of the anvil of FIG. 13 and side view of the half cell Braille embossing wheel of FIG. 9 where the half cell Braille embossing wheel is moved into position to delete a Braille impression.

FIG. 16 is a perspective cut away view C-C of FIG. 15. FIG. 16 shows the mating of the ridges between the grooves 957 with the divots 950. When a user intends to delete a Braille character, the paper is shifted half a cell up or down to remove the Braille impression. This is accomplished by aligning the ridges between grooves 953 with the divots 950 such that as the embossing wheel is moved into the anvil an opposite impression is created as the ridges enter the divots 950.

While the above description is illustrated in terms of specific embodiments, the drawings and examples are not intended to be limiting. Further even though only certain preferred features of the invention have been illustrated and described, many modifications and changes will occur to those skilled in the art. It is, therefore, to be understood that the appended claims are intended to cover all the true spirit of the invention.

I claim:

1. A Braille printer for embossing a substrate, comprising: an anvil and at least one embossing wheel, the embossing wheel being generally octagonal in shape and further comprising;
a peripheral portion;
a number of locations about the peripheral portion;
each of said locations having at least one position, each of said positions containing either at least one pin or no pin.

2. The Braille printer of claim 1, wherein the peripheral portion comprises 7 locations each location having three positions in a single column, each of said positions contains either a pin or no pin.

3. The Braille printer of claim 1 wherein the anvil has grooves along its length in mating alignment with the at least one pin of the Braille embossing wheel.

4. The Braille printer of claim 1, further comprising a pair of divots in a location having no pins.

5. The Braille printer of claim 2, further comprising a pair of divots in a location having no pins.

6. The Braille printer of claim 3, further comprising a pair of divots in a location having no pins.

7. The Braille printer of claim 6, wherein the divots are in mating alignment with the ridges between the grooves of the anvil for de-embossing a substrate.

8. The Braille printer of claim 1, wherein the at least one Braille embossing wheel is a pair of Braille embossing wheels configured back to back for embossing a single Braille cell simultaneously.

9. The Braille printer of claim 1 wherein the at least one Braille pint head is multiple pairs of Braille embossing wheels each pair configured back to back for embossing multiple Braille cells simultaneously.

10. The Braille printer of claim 8 wherein the anvil has grooves along its length in mating alignment with the at least one pin of the Braille embossing wheel.

11. The Braille printer of claim 10, further comprising a pair of divots in a location having no pins.
